(19) United States
(12) Patent Application Publication
(10) Pub. No.: US 2005/0191493 A1
(43) Pub. Date: Sep. 1, 2005

(54) Electrically conductive coatings with high thermal oxidative stability and low thermal conduction

(76) Inventor: Paul J. Glatkowski, Littletown, MA (US)

Correspondence Address: James Remenick;Powell Goldstein LLP, Intellectual Property Group, 901 New York Avenue, N.W., Third Floor, Washington, DC, 20001-4413, US

(21) Appl. No.: 10/978,212

(22) Filed: Nov. 1, 2004

Related U.S. Application Data
(60) Provisional application No. 60/515,419, filed on Oct. 30, 2003.

(51) Int. Cl. B05D 1/36; B32B 9/00

(52) U.S. Cl. 428/408; 427/180

(57) ABSTRACT

The present invention is directed to electrically conductive coatings of carbon that have high thermal oxidative stability and low thermal conduction. Coatings of the invention provide a surface resistivity to the coated substrate of 10² ohms/square, and preferably 10⁻² ohms/square. Coatings also provide the coated article increased thermal oxidative stability as compared to the uncoated article and articles coated with convention materials like carbon black and metals, as well as low thermal conduction. The invention is also directed to substrates possessing conductive coatings, methods of utilizing the coated substrates, and to methods of forming the coatings of the invention.

### REFERENCE TO RELATED APPLICATIONS

This application claims priority to U.S. Provisional Application No. 60/515,419 entitled “Electrically Conductive Coatings with High Thermal Oxidative Stability and Low Thermal Conduction” filed Oct. 30, 2003, the entirety of which is hereby incorporated by reference.

### RIGHTS IN THE INVENTION

This invention was made, in part, with support from the United States government under a grant from the United States National Aeronautics and Space Administration, Contract No. NAS 1-02116. Accordingly, the United States government may have certain rights in the invention.

### BACKGROUND

1. Field of the Invention

The present invention is directed to electrically conductive coatings of carbon that have high thermal oxidative stability and low thermal conduction. The invention is also directed to substrates possessing such conductive coatings, methods of utilizing the coated substrates, and to methods of forming the coatings.

2. Description of the Background

Protective coatings that provide multifunctional attributes are widely used in aerospace and in advanced electronic devices. Currently resistive films that are used on aeronautical and space platforms in high temperature environments have low durability and are costly to repair and maintain.

Coatings can be formed or fabricated as high Thermal Oxidative Stable (TOS) opaque resistive coatings for aircraft, spacecraft and ground based applications. Protective coatings that provide electrical conductivity in environments with high temperatures, high vibration characteristics, moisture, solvents, fuels and oxygen, typically have short useful lifetimes. The degradation of electrical properties after exposure to such environments reduces the primary function of the coating making repair or replacement necessary. The degradation of electrical properties can be attributed to failure of the binder or the conductive fillers.

Historically, the conductive fillers are metals or carbon black and the binder is a polymer in the class of polyimides or phenolics. If either primary component fails the properties of the composite coating/film will degrade.

It is well know that most high temperature polymers degrade at temperatures between 300° C. and 550° C. in short periods of time. Less understood but well documented is the degradation of polymers at lower temperatures over long periods of time. Polymers exposed to atmospheric gases at 200-250° C. for long periods (e.g. 1000's of hours) will degrade in mechanical strength, optical properties, adhesive properties, and ability to bind conductive fillers. This degradation is exhibited in filled coating by reduction in electrical conductivity, disbanding of the layer to the substrate, flaking and cracking of the film/coating. Another conventional example is the use of metal fillers in polymers to make conductive coatings. Metal are subject to oxidation, corrosion and reaction with environmental compounds aggravated at elevated temperatures.

Furthermore, degradation of the coating properties can come about through failure of the filler. For example carbon black is commonly added to plastics to increase electrical conductivity of the bulk composite formed from the mixture. However even if the polymer has a very high thermal oxidative stability, the filler may prove to be the weak link in the composite, such that the filler oxidizes, slough's off the surface, or reacts with other compounds in the environments. All of this will cause the coating's electrical and other properties to diminish. Even if the polymer where replaced with a high temperature material like a ceramic, the filler will still fail.

Buckyballs, nanotubes, and nanofibers form a continuum of carbon nanomaterials. Buckyballs are single fullerene molecules of carbon, such as C60, C70, etc. Single wall nanotubes (SWNT) are effectively the cylindrical version of buckyballs—a tube of carbon atoms with a diameter equal to that of a corresponding spherical buckyball (˜1.2 nm), and which may have buckyball hemispheres as end caps. A nanotube may have additional concentric cylinders of carbon, in which case it is a multiwall nanotube (MWNT, typically ˜3-10 nm). Some nanotubes are formed by a process that involves growth from a metal catalyst particle. In some cases, particularly smaller diameter nanotubes, the catalyst particle is thought to dance around the end of the nanotube, adding carbon atoms to the structure as it goes. In larger nanotubes, the catalyst particle remains static at the end of the tube, and adds to the entire rim of the cylinder at once, and a MWNT is usually formed. For smaller nanotubes, the allowed diameters are determined by the energetics of the curved carbon structure. For the larger nanotubes, the diameter is determined by the diameter of the catalyst particle (which sets the inner diameter of the core), the number of layers of catalytically grown carbon (which set the outer diameter of the core), and the amount of extra vapor deposited carbon that may form on them (which sets the final total diameter). These larger structures (˜80-200 nm) are termed nanofibers. Once a nanofiber is formed, it is possible to increase its diameter, through chemical vapor deposition, to the diameter of conventional carbon fibers (˜5-10 mms).

Pyrograf®-III material is a nanofiber. The Pyrograf®-I material is a full size carbon fiber—a, very fine, highly graphitic, yet low cost, carbon nanofiber. Pyrograf®-III is commercially available in diameters ranging from 70 and 200 nanometers and a length estimated to be 50-100 microns. Therefore, nanofibers are much smaller than conventional continuous or milled carbon fibers (5-10 microns), but significantly larger than carbon nanotubes (1-10 nanometers).

Electrical properties of carbon fibers include: high electrical conductivity in composites at low carbon fiber loading; reduced cost for electrically conductive and dissipative compound; and electrical conductivity without degrading mechanical properties.

Mechanical properties of carbon fibers include: increased mechanical strength of polyolefins up to four times; increased impact strength in polar resins; increased modulus of rubber compounds fourfold in high strain applications.

Chemical properties of carbon fibers include: chemical bonding to graphite planes to tailor composite properties; reactive oxygen, sulfur and nitrogen sites on carbon nanofiber surfaces; good interface between carbon nanofibers and polymer matrices.

Coatings that form electrically conductive and thermally insulative coatings are desired that also provide protection to a substrate from extreme environments.

### SUMMARY OF THE INVENTION

The present invention overcomes the problems and disadvantages associated with current strategies and designs and provides new tools and methods for imparting articles with thermal resistance and thermal oxidative stability, while providing a desirable surface resistivity utilizing carbon tubes.

One embodiment of the invention is directed to compositions containing carbon tubes that provide an article to be coated with such a composition an increased thermal oxidative stability, as compared with the uncoated article or the article coated with conventional materials such as carbon black, wherein the coated article has a surface resistivity of at least 10⁻² ohms/square. Carbon tubes are preferably carbon nanotubes or more preferably, carbon nanofibers. Preferably, surface resistivity is from 10⁻² to 10⁴ ohms/square.

Another embodiment of the invention is directed to methods of providing a thermal oxidatively stable coated article comprising coating at least a part of said article with a composition comprising carbon tubes such that said coating provides said article with a, surface resistivity of at least 10⁻² ohms/sq., an increased thermal oxidative stability, and a low thermal conduction, wherein the coating comprises less than 4% carbon tubes. Preferably, the entire article is coated or at least the sensitive portions thereof.

Another embodiment of the invention is directed to articles coated with compositions of the invention with the increased properties and enhancements provided by compositions of the invention. Such articles include, but are not limited to, electronic devises or components, airplane parts or systems, or parts for spacecraft (e.g. satellites, missiles, rockets).

Other embodiments and advantages of the invention are set forth in part in the description, which follows, and in part, may be obvious from this description, or may be learned from the practice of the invention.

### DESCRIPTION OF THE FIGURES

FIG. 1. TGA results for CB with multiwalled carbon nanotubes performed in flowing air (10 cc/min).

FIG. 2. TGA results for isothermal hold at 700° C. in flowing air (10-11 cc/min).

FIG. 3. TGA data of SWnT, MWnT, and CB; ramp at 10° C./min to 900° C. in air (flow rate of 10 cc/min).

FIG. 4. Electrical resistance vs. temperature for 0.5% wt carbon nanotubes filled with urethane coating, 60 μm.

FIG. 5. Isothermal hold at 316° C. in air, CP1 polyimide+SWnT composite coating on glass, 4 mils think.

FIG. 6. Resistance data for nanotube filled ceramic and conducting polymer.

FIG. 7. Resistivity of coating as a function of loading level for both CB and PIII carbon nanofibers.

FIG. 8. Resistivity of coating as a function of thickness for both 5% and 10% filler loadings.

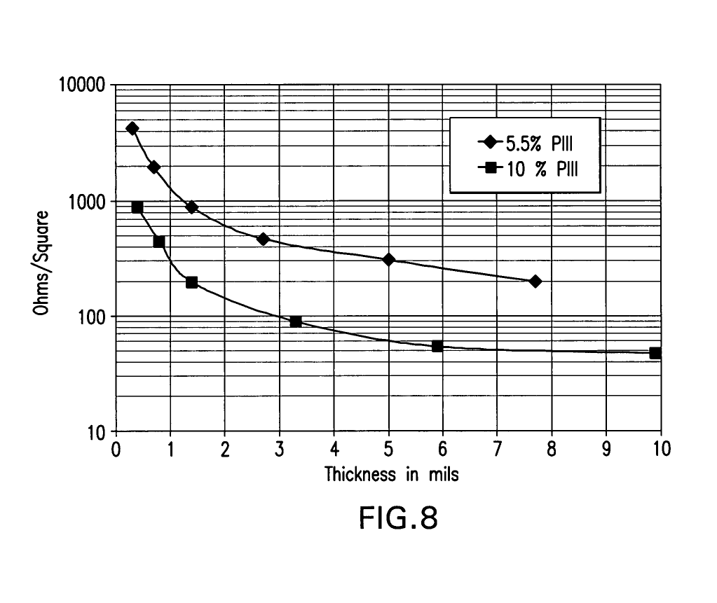

FIG. 9. Summary of TGA TOS data on coatings and base materials. Weight loss taken from slope of TGA curve. Isothermal hold temperature is 305° C. unless noted, airflow ˜10 cc/min.

FIG. 10. TGA results from 5% carbon nanotubes filled P12573 film and unmodified PI-2573 film. Both films were free standing and tested at: ramp 10.00° C./min to 375° C. then isothermal for 100 hours.

FIG. 11. Resistivity change during long term thermal exposure in air for both 5% loaded and 10% loaded coating specimens.

FIG. 12. Electrovac HT & long term test.

FIG. 13. Electrovac HT & short term test.

FIG. 14. XC72R short term test with annotations for TOS test tables.

FIG. 15. Pyraline coating with Electrovac loaded at 10% and virgin pyraline long term test.

FIG. 16. Pyraline coating with Electrovac loaded at 6% and virgin pyraline long term test.

FIG. 17. Virgin kapton and pyraline (no nanotubes coating) long term test.

### DESCRIPTION OF THE INVENTION

As embodied and broadly described herein, the present invention is directed to electrically conductive coatings of carbon that have high thermal oxidative stability and low thermal conduction. The invention is also directed to substrates possessing such conductive coatings, methods of utilizing the coated substrates, and to methods of forming the coatings.

Protective coatings that provide multifunctional attributes are use widely in aerospace and in advanced electronic devices. In these myriad of applications, the coated articles are often required to withstand environmental extremes such as, but not limited to, extremes of mechanical stress (e.g. physical stress), thermal stress (e.g. non-ambient and extremes of heat and cold), processing stress (e.g. repetitive stress), bonding stress (e.g. chemical stress), radiation stress (e.g. ultraviolet, infrared, near infrared), and also combinations of such stresses. Often the solution is to add layer after layer of protective coatings like resilient plastic polymers and metals, but these materials can and do interfere with conductivity and impose additional complications such as an increased weight.

It has been surprisingly discovered that conductive coatings formed of certain molecular structures of carbon can be both conductive and sufficient stable to external influences. In this present invention, it is demonstrated that other forms of carbon can be a replacement for carbon black. High TOS carbon materials can replace existing polyimide resins, while maintaining the same performance and processing characteristics found in the original aircraft coatings. Forms of carbon that demonstrate such utility, without compromising useful conductivity are carbon tubes, which include carbon nanotubes and carbon nanofibers. Carbon nanotubes may be single-walled, double-walled or multi-walled structures comprising sheets of buckeyballs rolled into tubes. Carbon nanofibers comprise sheets of carbon molecules buckeyballs rolled into cones that coalesce into fibers while maintaining a hollow interior forming a hollow tube.

Disclosed herein are methods for forming electrically conductive and thermally insulative carbon coatings that provide protection to a substrate from high and/or low temperature environments. Coatings are formed from high temperature polymeric or ceramic precursors and carbon nanotubes and/or carbon nanofibers, or combinations thereof. Carbon in these forms is very conductive and of high aspect ratio, permitting use of a very low loading level to achieve a continuous conductive network of particles. Carbon nanotubes and/or nanofibers can be mixed throughout the coating layer or concentrated toward one surface of the layer. The resulting electrical properties can range from surface resistivity from 10¹² to 10⁻² ohms/square depending on loading levels and construction of the coating. Some useful ranges for surface resistivity that can be achieved are 10¹⁰ to 10⁶ ohms/square, 10⁸ to 10⁶ ohms/square, 10⁶ to 10⁴ ohms/square, 10⁴ to 10² ohms/square, 10² to 10⁰ ohms/square, 10¹ to 10⁻¹ ohms/square, and 10² to 10⁻² ohms/square. The thermal conductivity that can be achieved is largely dependent on the matrix material and is not substantially affected by the nanotubes. In fact the mechanical properties of the matrix material generally dominate the properties of composite layers.

Carbon tubes are advantageous over typical fillers like carbon black and metals (e.g. silver, gold) for several reasons. For example, conductive fillers like metals typically require high loading levels, such as much greater than 6%. Carbon tubes, in contrast, allow for lower filler levels of less than 6%, less than 5%, less than 4%, less than 3%, less than 2%, less that 1% and even less than 0.5% (e.g. 0.2%, 0.1%, 0.05%, 0.02%, 0.01% and even less). Low loading level also mean that other properties, such as mechanical, thermal, processing, and bonding, of the matrix material are unaffected by the presence of the conductive additive.

The high thermal stability of this form of carbon allows for use of the coating at temperatures as high as 1,000° C., preferably at least 1,500° C., and more preferably at least 2,000° C. and even higher in inert environments. In oxygen containing environments, thermal stability of this form of carbon allows for use of coatings at temperatures as high as 400° C., preferably at least 600° C., and more preferably at least as high as 800° C. or 1,000° C. and even higher. Also preferably, coatings of the invention allow for thermal stability after repeated exposures to extremes in temperature. Increased high thermal stability is enhanced when very low residual metals are present in the composite and carbon. The light weight of carbon combined with low loading levels resulting in a light-weight composite coating, which was heretofore unavailable. Further, the high aspect ratio of this carbon prevents depletion near the surface. Fibers are entangled and/or partially embedded in the matrix preventing removal at the surface. Thus, coatings of the invention allow for the thermal protection of articles from constant and/or repeated extremes of temperature and other environmental forces like radiation and chemical or physical degradation.

Coating compositions may further contain high-temperature ceramics, such as aerogels, high-temperature polymers, glasses, or combinations of such materials to enhance and provide additional desirable properties to the invention.

The following examples illustrate embodiments of the invention, but should not be viewed as limiting the scope of the invention.

### EXAMPLES

### Example 1

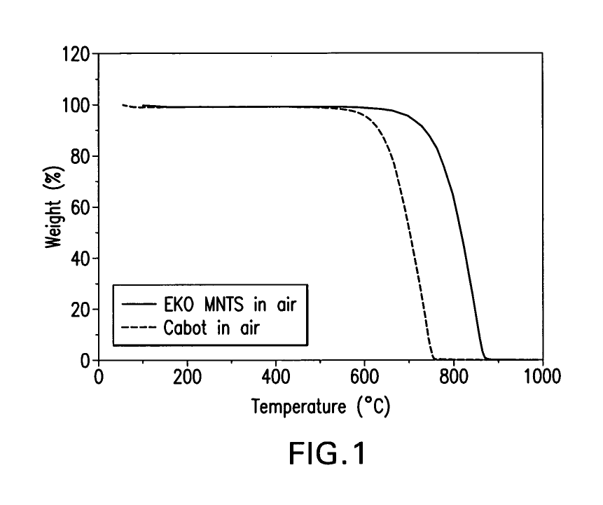

Thermal Oxidative Stability (TOS) was evaluated for carbon black, carbon nanotubes and carbon nanofibers. Two plots were generated: 1) short term TGA and 2) Long-term TGA ˜100 hours at 700° F., collected on both high electrical conductivity carbon black (Cabot Corporation) and purified multiwalled carbon nanotubes (see FIG. 1). From this data it is clear that the onset temperature of degradation is higher for the carbon tubes than for the carbon black (CB). Also, there were very low (<0.3%) residual weight on the nanotubes, indicating very low noncombustible contaminates like metals. EKO MNTS are multiwalled carbon nanotubes (Electrovac GesmbH, Austria).

The long-term testing shows gradual weight loss for the CB throughout the 100 hours period of the test with total loss of ˜5.5% Wt. However for the nanotubes, zero weight loss was recorded after 70 hours at 700° F. No change in weight after 70 hours at 700° F. Subsequent testing at 850° F. showed the same result. Test conditions were as follows:

Short-term: Ramp to decomposition test: 10° C./min ramp to 1,000° C., observe the onset of decomposition and residual weight. TGA results on a series of nanotubes and the carbon black were performed.

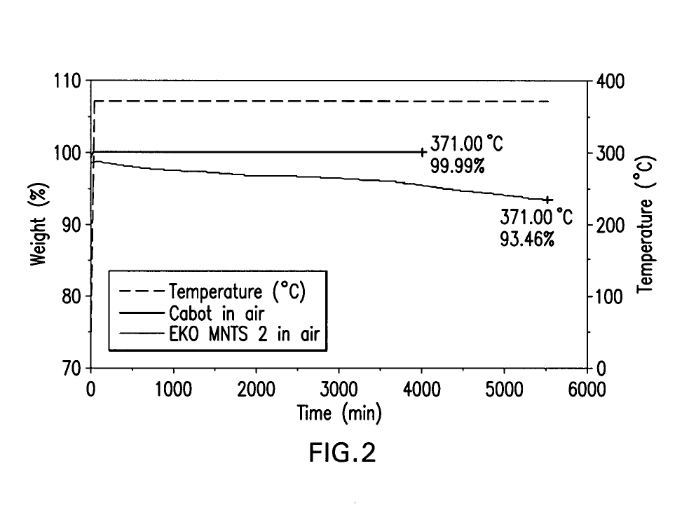

Long-term: Isothermal hold test: heat and hold at 371° C. (700° F.)for 100 hours in flowing air, using 10-11 cc/min, observe weight loss at 100 hours and slope of line, also any transitions or inflections in line during run (FIG. 2).

TOS of the nanotube is much higher than that of CB, which is typically used in existing conductive coatings. Carbon nanotubes provide a more stable form of conductive additive for any resin system used in forming the coating. In addition the very low, essentially zero, metals content will not contribute to degradation of the resin at high temperatures.

### Example 2

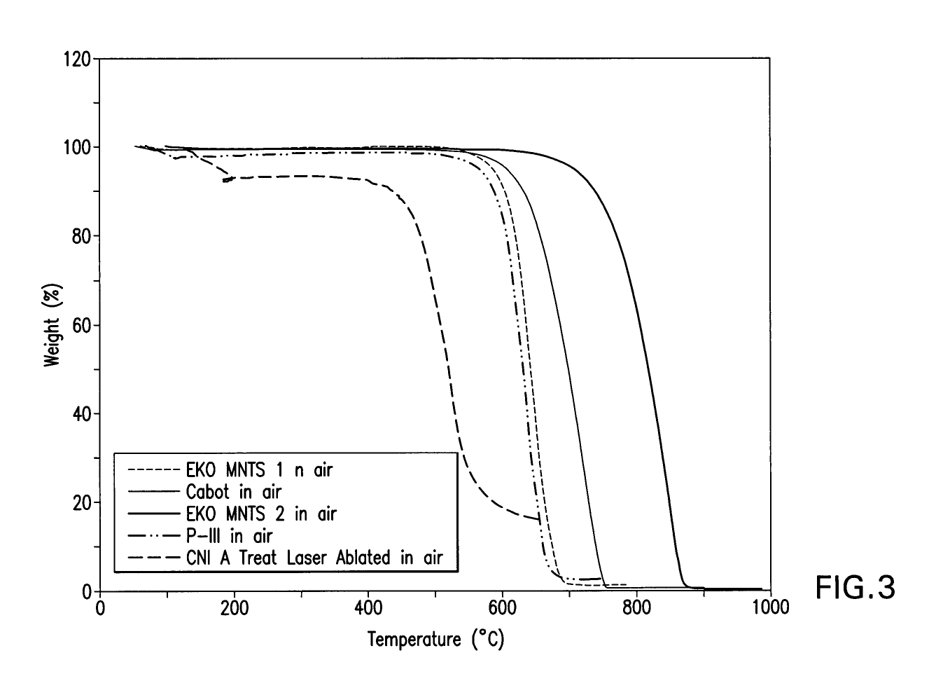

Additional Thermal Oxidative Stability (TOS) evaluations were performed for different form of carbon for use in conductive coatings. The ramp data of FIG. 3 indicates two factors of interest when evaluating the TOS of neat carbon in air. CNI A are single walled carbon nanotubes (CNI, Inc., Houston, Tex.). The first is the onset of degradation and the second is the residual weight after complete decomposition. Note that the residual weight seems related to the onset temperature; which could be due to metal content. Short term TGA data were collected using conditions where the sample is ramped till failure, and correlates to the long term TGA test performed at isothermal hold.

Essentially, the higher the on-set temperature during ramp to failure, the lower the weight loss during isothermal hold. Additionally, the lower the residual weight after full decomposing the higher the onset temperature. These patterns could be misleading should be environment or other conditions be altered.

Carbon tube samples evaluated were not specifically produced for high thermal stability in air. Results are generally dependent on contaminate level and not on the intrinsic properties of the tubes. Since most applications for carbon tubes are not in a very high temperature oxygen rich environment, most development efforts have not had such a focus.

### Example 3

### Electrical Properties

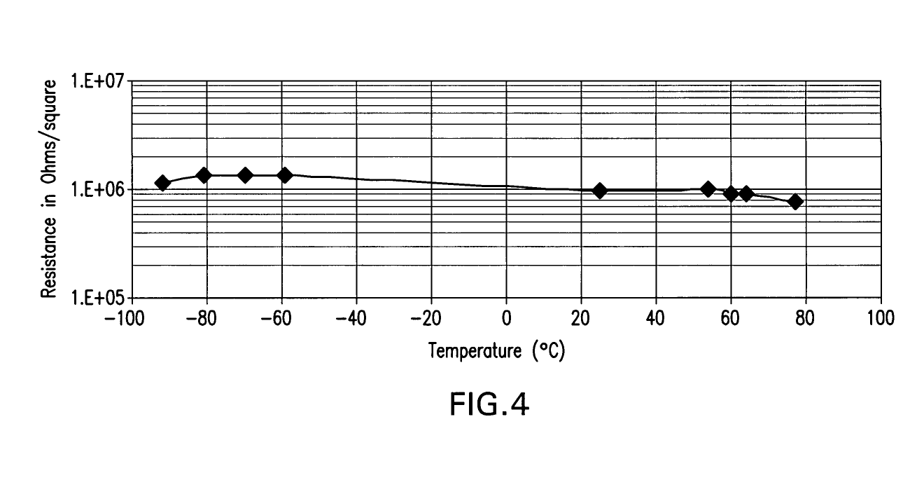

Electrical properties as a function of temperature were determined for carbon tube filled urethane and ceramic coatings. Urethane polymers provided the best near-term solution for a well dispersed filled system for coating and optical testing. The castable ceramic (Al₂O₃) allowed exploration of the high temperature behavior of dilute carbon tube fillers. For simplicity, only data for 0.5% loading of nanotubes in the various matrices is presented in FIG. 4. Higher loading of NTs were tested.

Electrical resistance for an ESD coating should be between 10⁶ to 10¹⁰ ohm per square for most space applications. Additionally the ESD coating should maintain electrical conductivity throughout the operational temperature range experienced in space. Typically, satellites experience wide temperature cycles due to solar radiation combined with the varying flux density of charged particles. On spacecraft with outward-facing dielectric materials (which most are), the dark side of the vehicle can become highly charged (negative 1 KV) due to the lack of photoelectrons, while the sunlit side can be almost entirely charge free. This creates highly asymmetric charging sheaths and total frame charging levels less than if the vehicle was entirely out of the sun. When the vehicle is in total darkness, it has about a factor of ten higher potentials than sunlit charging. Therefore, the ESD coating should be capable of distributing charge regardless of the environmental conditions. To this end, electrical resistivity of the carbon tube filled coatings was measured from negative 92° C. to as high as positive 450° C. Results shown in FIG. 4 were obtained from a urethane coating on polycarbonate. Electrodes were painted using silver epoxy to form two parallel electrodes about 3 cm apart, 3 cm long, and a few millimeters wide. Embedded in this silver were two electrodes leading back to a Resistometer. The entire test cell was wrapped in polyethylene and submerged into isopropanol. Alcohol served as a heat transfer medium, which was in turn, cryogenically cooled to the test temperature.

### Example 4

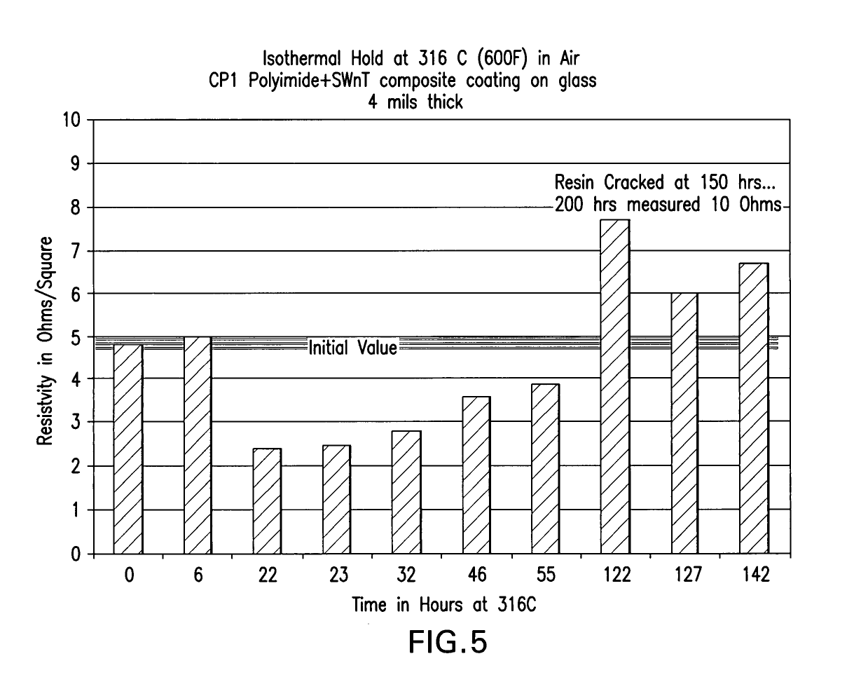

Results obtain during a test as to the high temperature stability of carbon tubes compounded in resin to provide a low resistivity (<10 ohms/sq) coatings are shown in FIG. 5. Sample was made from unpurified SWnT compounded with CP1 Resin (SRS Technologies, AL). CP1 is not a high temperature polyimide and has a Tg lower than the test temperature of 316° C. Better results using a high temperature imide like AFR700PE are likely. Nanocomposite resin was coated on to a glass slide, dried, and painted with thin silver electrodes along each edge to form a square area in the middle. To these electrodes were connected copper leads back to a DVM to monitor resistivity during the ramp and hold at 316° C. Results are shown for a period of ˜150 Hrs in FIG. 5. Films then began to crack and peel. Testing terminated at 200 hours since the test area was now damaged too much to allow accurate monitoring of the resistivity. Final resistivity was 10 ohms/sq, not adjusting for area reduction due to film failure.

High temperature data was obtained by mounting the same sample in a furnace with a thermocouple placed in contact with the surface. Sample remained at high temperatures for several hours without any noticeable changes. Results were encouraging since the electrical resistance was unchanged throughout this temperature range, which was actually much lower than needed for ESD application. Therefore, even lower loadings could be used. Other systems based on conducting polymers suffer from a rapid reduction in electrical conductivity as the temperature decreases. Here the nanotubes were unaffected at low temperatures because they did not depend on the same chemical dopant conduction mechanism, which is reversible. Next was determined how high can one achieve and how does this compare to alternative technologies.

### Example 6

Thermal stability of resistance or conduction in these coating simply could not be better. The limitation was the matrix material and not the conducting filler. Samples of nanotube filled epoxy coated onto Kapton and PC have electrical resistance between 1-5 Mohms constant from −77° to 110° C., where the PC substrate bubbled form overheating, although the coating still functioned. To determine if the same performance extends to higher temperatures, an experimental tangent was taken and a batch of carbon tube filled AL₂O₃ castable ceramic made.

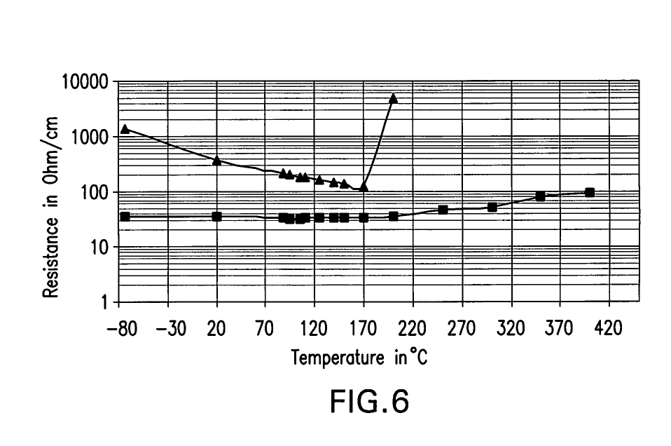

Testing thermal stability at even higher temperatures required a high temperature matrix. A castable Al₂O₃ ceramic was selected and loaded with 0.5% by weight carbon nanotubes. Electrodes were imbedded into the bulk of the 2 mm thick slab which was mounted into the furnace. Resistance as a function of temperature for nanotube material and for a proprietary electrically conducting polymer filled polymer were compared in FIG. 6. Note the conducting polymer fails at about 200° C. and became more resistant as temperature drops below 20° C., whereas the nanotube based material had a flat response to temperature. The slight up trend seen at higher temperatures is most likely due to contact resistance between the electrodes and the material. Test to determine optical properties were next determined.

### Example 6

### Coating Evaluation

Coating trails were performed to find the relationship between loading levels, coating thickness and resulting resistivity. Test results collected on Pyraline 2573 coatings (compounded with conductive filler and Modaflow leveling agent) and on the base materials were determined. All the Pyraline films were cured using the cure schedule (noted herein under Coating Evaluation), unless otherwise noted. Several square feet of coatings were made on Kapton substrate for use in testing.

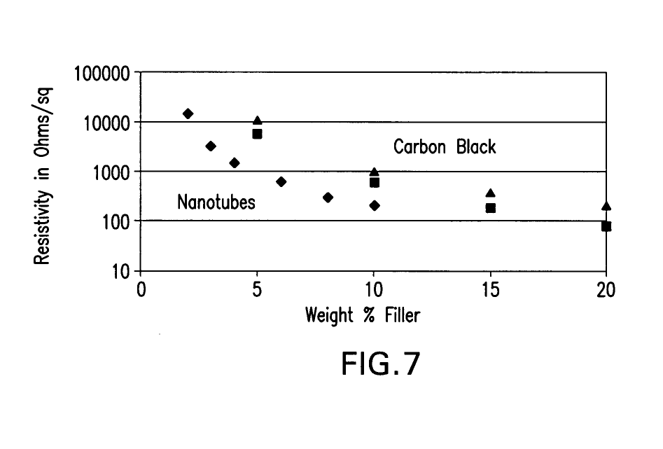

A series of coatings were compounded using a ball mill to determine the relationship between loading level and coating resistivity. The goal was 200 and 90 ohms/sq as target coating resistivity. Also evaluated were current filler to have a basis which to compare coating by. The results of one such test is shown in which it was initially concluded that a loading level of 5% yields a coating resistivity of ˜900 ohm/sq, and a loading level of 10% yields a coating resistivity of ˜200 ohms/sq in FIG. 7. In subsequent testing, it was discovered that the coating resistivity actually drops after thermal exposure. Combining this observation with improvements in compounding methods, a further lowering of loading levels can be achieved and still yield the same resistivity. Consequently, current formulations can be adjusted and made at 3.5% and 8% loadings for 200 ohms/sq and 9800 ohms/sq respectively.

### Example 7

The next coating evaluation was performed to determine the coating resistivity as a function of thickness. One goal was to produce coatings between 1 and 4 mils thick, therefore coatings spanning this thickness range were created and resistivity measured. From this data, it was concluded that a coating thickness of at least 3 mils is desirable to avoid resistivity variations due to thickness. Clearly coating made below 1.5 mils will exhibit resistivity variations due to coating thickness much more sensitively than the thicker coatings.

### Example 8

### Coating Tests

Testing performed fell into three categories: 1) TOS/TGA test on formulated coating and base materials, 2) Electronic resistivity during thermal aging, and 3) Prescreening test matrix as provided.

TOS/TGA Tests

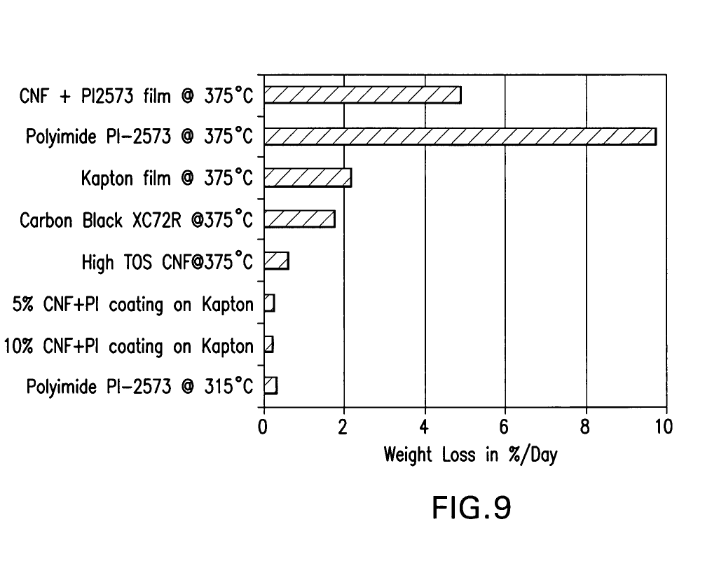

Considering the end use for these coatings, evaluation of the TOS from the perspective of weight loss was continued. Several coatings variations were evaluated by monitoring weight loss during both rapid heating to failure (short term test) and isothermal hold (100 hour test) conditions. A list of the coatings evaluated is shown in FIG. 9.

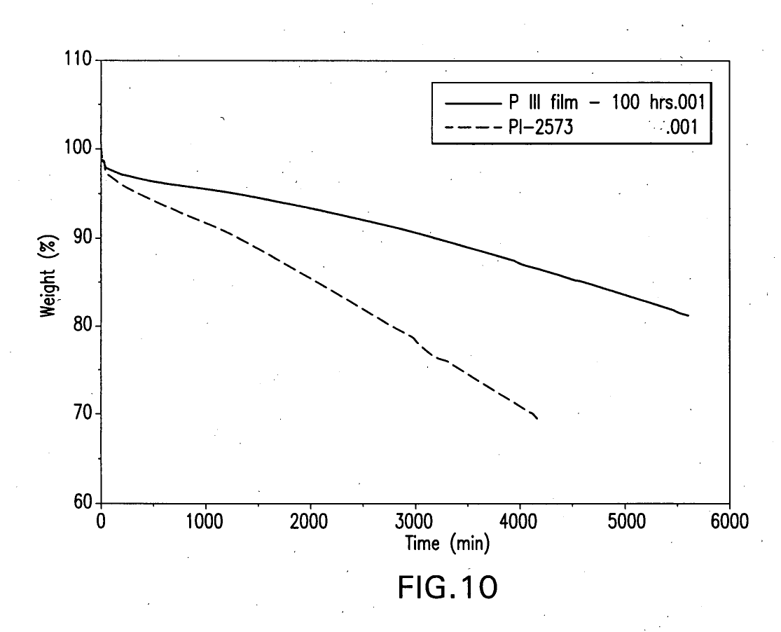

One interesting result of these evaluations is the observation that the loading of nanotubes into the polyimide films greatly reduces the weight loss during high temperature isothermal hold (FIG. 10). This result is surprising given the low loading level of the filler. The filler may inhibit oxygen diffusion in to the film.

Electronic Resistivity During Thermal Aging

To further evaluate the thermal oxidative stability of these coatings, a long-term thermal ageing test with continuous monitoring of electrical resistivity was prepared.

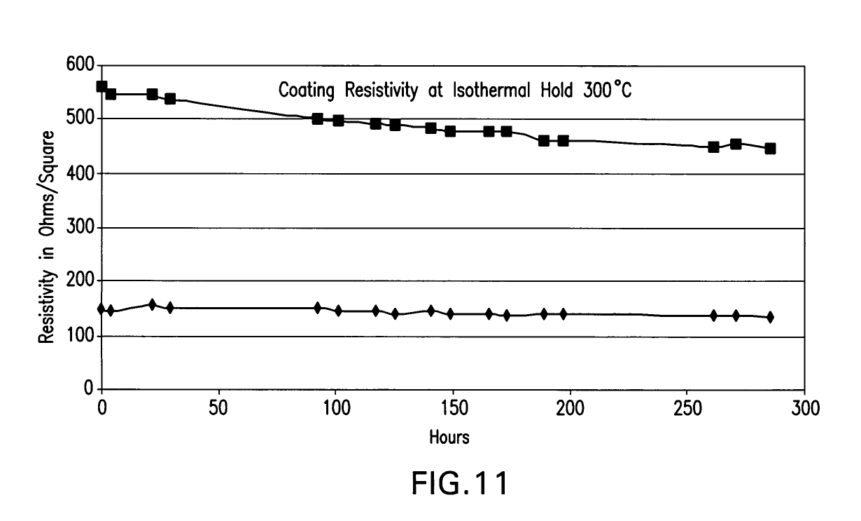

Both specimens were pre heated to 300° C. and held to assure complete cure and remove water (FIG. 11). Coating very slowly reduces in resistivity over time at 300° C. This correlates well with TGA analysis which shown a slight but steady weight loss at his temperature and time period.

TGA TOS Data Collected on Formulated Coatings and Resins as Follows:

Kapton and pyraline (no conductive fillers) coatings, long-term test.

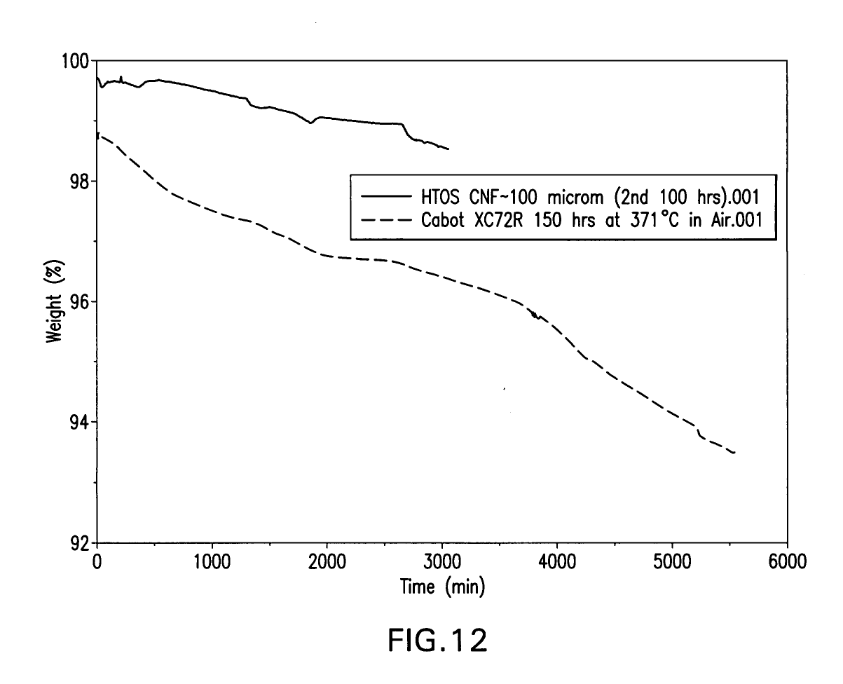

1) Electrovac HT in Air Long-Term, Compared to Carbon Black Long-Term (FIG. 12).

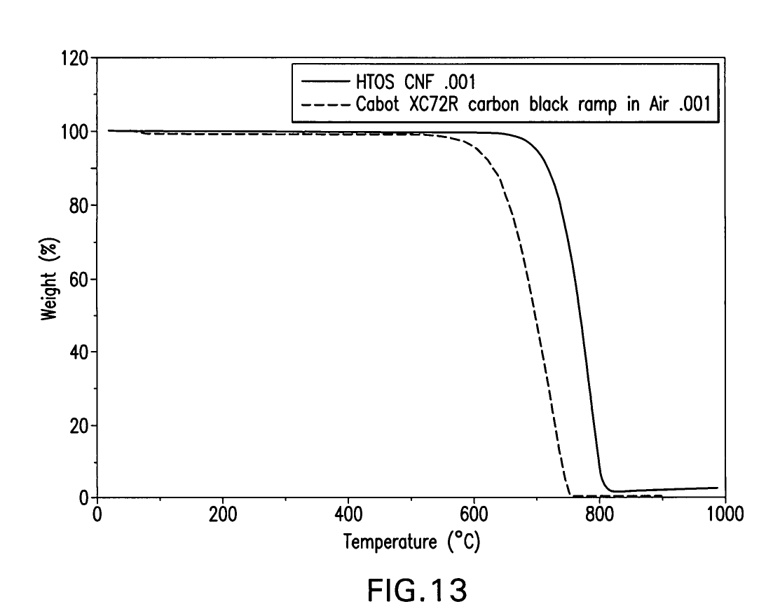

Test parameters: HTOS CNF (high thermal oxidative stable carbon nanofibers)
Ramp 10.00° C./min to 371.00° C.
Isothermal for 3016.60 min.
Cabot carbon black—Ramp 10.00° C./min to 371.00° C.
Isothermal for 5508.69 min.
   2) Electrovac HT in Air Short Term Burn Compared to Carbon Black Short Term. (FIG. 13).

Test parameters: Ramp 10.00° C./min to 1000.00° C.

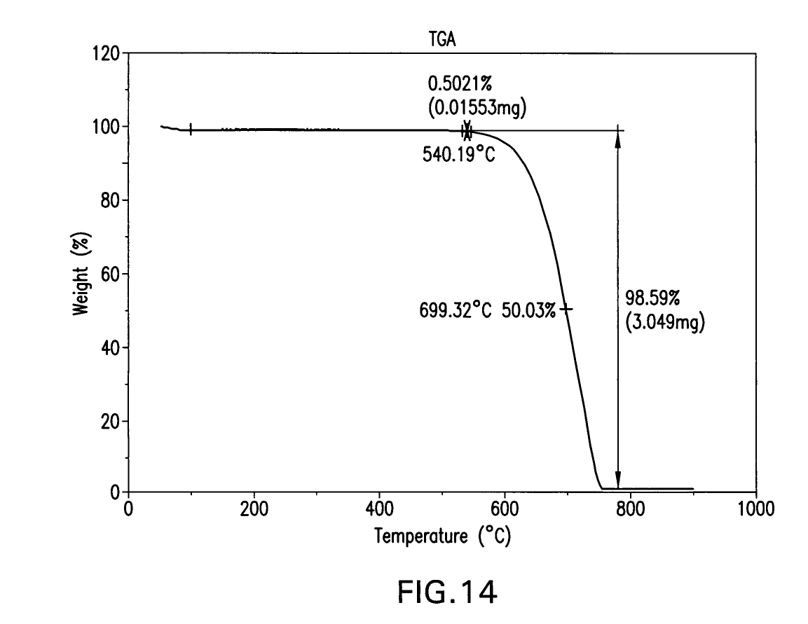

3) XC72R (Carbon Black, Cabot Corp.) Short Term Test with Annotations for TOS Test Table (FIG. 14).

Test parameters: Ramp 10.00° C./min to 1000.00° C.

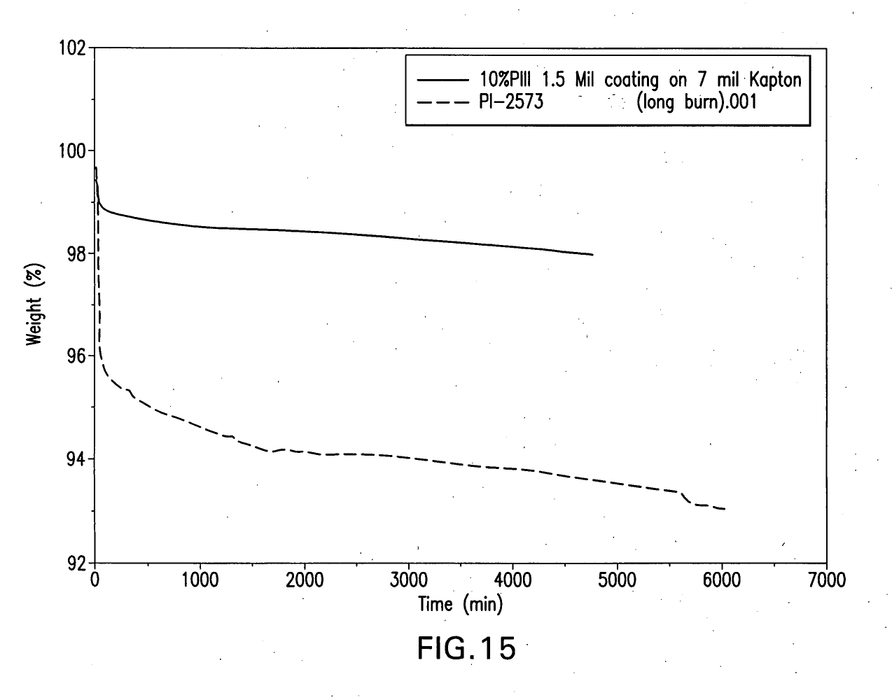

4) Pyraline Coating with Electrovac Loaded at 10% and Without any Filler, Long-Term Test (FIG. 15).

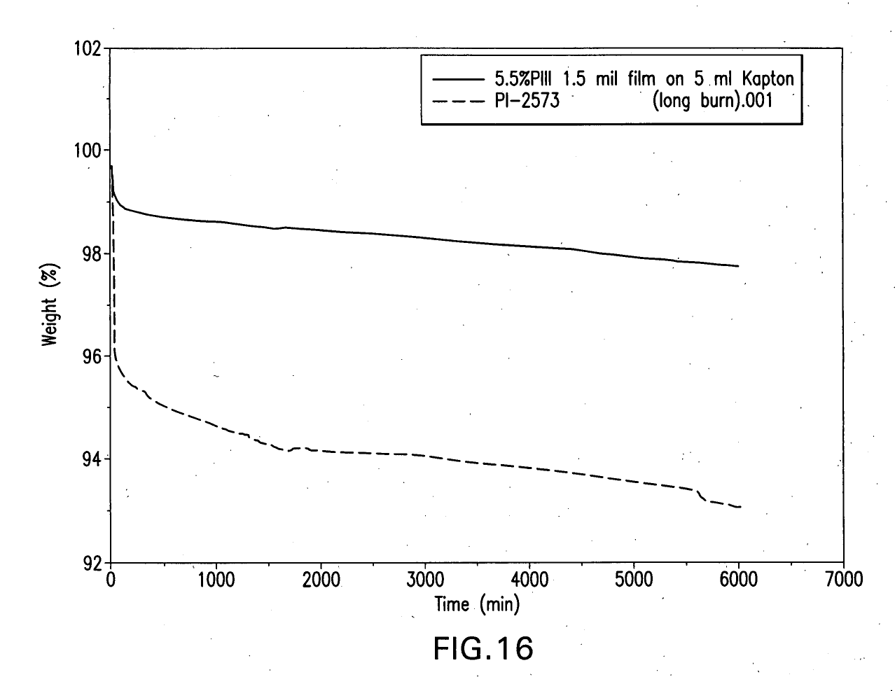

Test parameters: Pyraline 2573 coating loaded with 10% Electrovac tubes.
Ramp 10.00° C./min to 305.00° C.
Isothermal for 4734.38 min.
PI 2573 without any filler.
Ramp 10.00° C./min to 305.00° C.
Isothermal for 6000.00 min.
5) Pyraline Coating with Electrovac Loaded at 6% and Without any Filler, Long-Term Test (FIG. 16).

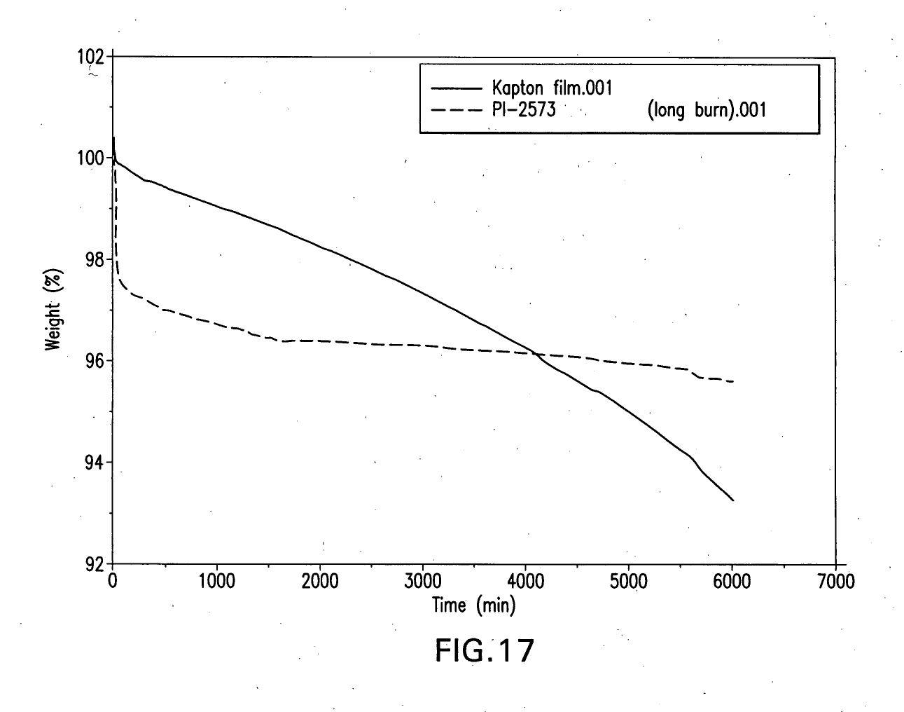

Test Parameters: Pyraline 2573 coating loaded with 5.5% Electrovac tubes.
Ramp 10.00° C./min to 305.00° C.
Isothermal for 6000.00 min.
PI 2573 without any filler.
Ramp 10.00° C./min to 305.00° C.
Isothermal for 6000.00 min.
   6) Virgin Kapton and Pyraline (No Nanotubes Coatings) Long Term Test (FIG. 17).

Test parameters: Kapton film Ramp 10.00° C./min to 375.00° C.
Isothermal for 6000.00 min. (repeated at 315° C.).
Pyraline 2573 Ramp 10.00° C./min to 315.00° C.
Isothermal for 6000.00 min.

Formulated coatings using down-selected set of four types of nanotubes, to evaluate electrical and dispersion properties. Materials: Pyraline resin, leveling agent, nanotubes, Kapton substrate. Performed high temperature TOS testing on formulated coatings and constituents. Performed more detailed prescreening tests on best formulations. Completed scale-up of best polymer formulation. Prepared over 60 coated Kapton sheets (average size 1 ft²). Large area ESD coating on PET film were prepared and tested.

With these experiments, high thermal oxidative stable (TOS) resistive coatings were fabricated and tested. The best candidate fillers performed prescreening tests on a variety of resin formulations, coated sixty (60) test plaques. A series of transparent ESD coatings on PET were prepared using a new automated coating system.

One goal was to have a replacement for carbon black, utilizing high (TOS) nanotubes in R241 spray coating systems, while maintaining previously properties and coating application processes. Essentially all materials previous qualified for this application were used, except the carbon black, and reformulated with carbon nanotubes.

The coatings for the screening test were provided in the form of a film incorporated onto Kapton. This is the result of acceptance of Kapton films as the substrate for testing and that R241 has a resin base of Pyraline 2573 (prepolymer or polyamic acid). Consequently, when formulating the nanotube into Pyraline (HD MicroSystems), coating on Kapton and curing the composite, the resulting films is essentially a Kapton film with nanotubes embedded on one surface.

Development focused on the use of three sources of multiwalled nanotubes, all of which pass the TOS and commercial availability requirements. A final selection to one source was made based on commercial availability and cost. This allowed for a more focused evaluation of the coating properties of one type of filler. Two coating formulations were prepared using one type of filler to provide the requisite 200 ohms/sq and 900 ohms/sq coatings for evaluations.

Some compromises were made in coating performance. As various formulations were prepared, coated, and evaluated, it was found that the relationship between loading level and electrical properties was strongly dependant on mixing time. Although it is possible to over-mix (reduce aspect ratio of the filler and conductivity of coating), under the right conditions in the ball mill it is very unlikely to become significant for very long mixing times. It was observed that longer mixing under gentle rolling of the mill resulted in lower film resistance. At some point, further milling will have no significant effect on the coating resistance. Since such a large number of films were required for delivery and due to constraints in process equipment, the loading level was compromised to reduce mixing times. Formulations yielding 200 ohms/sq could also yield 40 ohms/sq with additional mixing time (days). A high loading level was maintained to reduce mixing time. The 200 ohms/sq target could have been met with much lower loading level, given more mixing time. A coating with less filler and the same electrical properties should also show improved mechanical properties and adhesion to surfaces. The details of the coating preparation and testing are provided herein.

An Automated Coating Machine (ACM 1) was designed and built for generating uniform A3 sheets of transparent conductive coatings based on single walled nanotubes. However, similar coating machines are commercially available. As an aside, the multi-walled nanotubes selected for use in the high TOS coatings do not provide good transparent films and are not utilized on this coating type. Several sheets were made and tested.

### Example 9

### Coating Requirements

Desired Resistive Properties

Three (3) material coating types including: coating system exhibiting 200 ohms/square; coating system exhibiting 900 ohms/square; and a third system to be determined based on initial test results. The baseline coating thickness will range from between 0.002 to 0.004 inches.

Material Processing and Form

A preferred processing method for the high temperature resistive layers is: formulation of a homogeneous coating mixture composed of carbon nano-tubes and HD Microsystems (formerly DuPont) P12570 resin; spray application of the resin/carbon nano-tube mixture as a single, homogeneous coating layer onto unloaded Kapton substrate material; cure processing—provided R-241 600° F. cure process to provide a sheet of resistive material.

Material Quantities

Sixteen 16-inch×16-inch sheets of each material type: Three (3) separate systems, 16 sheets each, 48 sheets total. The resistive materials sheets experienced the following test conditions: oxidation exposure at 600° F. followed by electrical testing. Inert atmosphere exposure at 600° F. followed by electrical testing. Exposure to fluids, then 600° F. exposure followed by electrical testing, including: lubricant (MIL-L-7808); hydraulic fluid (MIL-H-5606); jet fuel (JP-8); water at 140° F.; moisture/thermal cyclic exposure to 500° F. followed by electrical and mechanical testing. Bonding compatibility testing with fiberglass-polyimide laminate after exposure to 140° F./95% relative humidity for 5 days, thermal flash exposure followed by electrical testing, adhesive compatibility testing with associated vehicle-based materials.

These items constitute the baseline requirements and planned testing of the resistive test sheets.

Since the discovery of carbon nanotubes in the early 1990's, there have been a number of carbon nanotube technologies and manufacturing methods that produce these novel materials. The first criterion was determining which vendor met the TOS threshold similar to carbon black (Cabot XC72R CM). The down selection criteria were based on thermal oxidative stability (TOS), metal contamination, material cost and production availability. Utilizing thermo-gravimetric analysis (TGA), each sample provided was ranked for thermal stability in air and metal contamination (artifact from manufacturing process).

Table I shows the sizes, thicknesses and loading levels of the various plaques fabricated (polyimide {Pyraline 2575; HC Microsystems} blended with carbon nanofibers {PIII, Applied Sciences}). Sample numbers refer to internal reference numbers. Further testing of resistivity by incorporating 15 wt % nanotubes in resin further defined candidate material. Those materials that met the TOS, TGA and resistivity requirements were tabulated in Table II. The final factor determining the filler material was cost and production availability. Pyrograf 111 PR-24 HHT nanofiber had the lowest resistivity (Table III).

Coating Evaluation

The preferred filler, Pyrograf 111 PR-24 HHT (PIII) was used as the conductive filler for its enhanced thermal and electrical characteristics. Further coating trials were performed to find the relationship between loading levels, coating thickness and resistivity. Pyraline 2573 was the resin system used in developing the ESD coatings and compounded with conductive filler and Modaflow leveling agent. The original resin used was defined as Pyraline 2570, but due to this resin being discontinued by the manufacturer, Pyraline 2573 was substituted as an equivalent. According to the specifications, Pyraline 2573 is exactly the same resin formulation/chemistry as Pyraline 2570 but made with lower solids content. Furthermore Pyraline 2573 is typically used in the microelectronics industry during the processing of silicon wafers and is available in large quantity. All the Pyraline films coated with PIII nanofibers were cured using the cure schedule below unless otherwise noted.
a.) Ambient temp @ 1-5 F/minute to 270° F. held for 60 minutes;
b.) 2-5° F./minute to 450° F. held for 60 minutes;
c.) 2-5° F./minute to 600° F. held for 2 hours; and
d.) Cooled at 3-15° F./minute to ambient temp.

Initially, a series of coatings were compounded to determine the relationship between loading level and coating resistivity. This relationship was also determined for carbon black as a baseline to compare the coatings. The carbon nanofiber are inherently more conductive than the carbon black filler and can achieve lower resistivity with lower filler amounts than carbon black. A 5 wt % PIII filler concentration in Puraline 2573 resin yields a coating resistivity of ˜900 ohm/sq and 10 wt % PIII yields a coating resistivity of ˜200 ohms/sq. All coatings were coated to a thickness of 3 mils. In subsequent testing, however, it was observed that the coating resistivity decreased after thermal exposure (Table I). Combining this observation with improvements in compounding methods, the nanofiber concentration was lowered to 3.5% and 8% loadings for 200 ohms/sq and 980 ohms/sq, respectively. The coating resistivity as a function of thickness has a similar relationship to weight % of filler.

This may be attributed to the increase probability of contacting an adjacent conductive species either by increasing concentration or thickness.

Prescreening Test Matrix

Prior to scaling-up coating formulations and testing large numbers of specimens, a prescreening evaluation was conducted to identify potential failures and make corrections. Test matrices are shown in Tables IV and V. In all instances, plaques generated from Table I (which were used in Tables X-XIV) out performed the same polymer loaded with carbon black and in many cases significantly outperformed (e.g. 2×, 4×, 6×, or 10× better).

Initial experimentation utilized sonication and high shear mixing in characterizing the resistivity with thickness and filler concentration. In small batches, this process was easily managed, but larger batches required longer sonication and high shear mixing time. The increase in mixing time proved detrimental to the electrical performance by reducing the aspect ratio of the PIII resulting in higher concentrations for the same level of performance observed in smaller batches. Also, with larger batch sizes the fibers are not “untangling” from one another, which ultimately affecting electrical performance (Table VI).

To solve this scale-up issue, ball milling was employed to compound the nanofibers in the Pyraline resin. The process development strategy utilizing this technology focused on a loading level of 10% PIII in Pryaline, and evaluated extractions at various times during ball milling. Resistivity measurements were taken on each extraction after being cast to a thickness of 3 mil. The total number of hours of mixing had a substantial influence on the final ohms/sq. values and required three days to fully develop properties. Samples from extractions observed under a light microscope showed increasing dispersion and untangling of PIII fibers as mixing time increased.

Further tests at 7.5 wt % PIII were ball milled for 24 and 48 hours, cast and evaluated. Results at 7.5 wt % PIII produced resistivity higher than the target of 200 ohms/sq. Therefore, the concentration was increased to 8 wt %. The project timeline prevented the ball milling processing time to be 72 hours long. As a compromise, 56 hours was selected since earlier testing showed that more than 48 hours of milling time was necessary to meet the performance requirements. A summary of the ball milling experimentation was tabulated (Table VII).

Similarly, the same design methodology was used to produce coatings with electrical properties in the 900 ohms/sq. It was determined that 4 wt % PIII ball milled for 56 hours produced 900 ohms/sq. coating (Table VIII). Therefore, in larger batch sizes ball milling shows equivalent if not improved electrical properties than sonication and high shear mixing. Although, there was a significant increase in mixing time, the ball milling method slowly mixes and blends the components to produce a more uniform coating material. Longer milling times may further improve the electrical performance of the coatings.

Coating Tests Results

Test results of carbon nanofibers on Kapton are provided in Tables X-XIV. In brief, all coatings passed these tests with only one failure. The failed coating was exposed to 500° F. for one week in air and delaminated from the Kapton substrate during the adhesion test. The substrate may have been locally contaminated since other parts of the specimen had better adhesion. A tape adhesion test was performed according to ASTM D3359 test method B, using a commercially available test kit. The adhesion by tape test is used to establish whether the adhesion of a coating to a substrate delaminates after exposure to certain environmental conditions. Samples were rated in accordance with the scale illustrated in Table IX.

Preparation of Test Plaques

Mixing of Nanotubes Material. Mixing of the PIII nanofibers was achieved by filling a Size 0 Roalox Mill Jar from U.S. Stoneware half full of ½″ by ½″ non-porous Burundum Cylinders. The ball mill was charged with 800 g of Pyraline PI 2573 resin and the required PIII nanofibers to make 4.0 wt % and 8.0 wt % batches (Table XV). To improve casting properties, 0.5 wt % Modaflow leveling agent was added to the mixture. Finally, the ball was capped and rotated at 35 RPM for three days.

Separating Resin from the Ball Milling Material

After ball milling, the resin was observed for uniformity using an optical microscope. Some nondispersed (large) particles always remained and were filtered while removing the resin from the media. Resin was discharged from the ball mill jar by simply pouring into a container without allowing any milling media to stay in the jar. The ball mill jar was then turned upside down onto a U.S. Standard Sieve #8 with 0.0937 in. Larger particulates (which may be minimized with further ball milling) were then filtered under pressure. This was accomplished by pouring the mixture into a stainless steel filter and processed under compressed nitrogen. Since the process required several steps in producing a resin; an effort was made to determine how much resin was lost during processing (Table XVI). Recovery yield of several of batches which averaged around 95%. To minimize the overall loss of material the ball mill was not washed between batches so that the small amount of material left in the container would be utilized in the next batch.

Casting of Films

The coatings were cast on a 5-mil Kapton film that was taped to a glass plate. The glass was cleaned before each piece of Kapton was taped onto the surface to insure no contaminants were present. The Kapton film was washed and a bead of resin was poured across the film. The film was cast with a Gardco Adjustable Micrometer “Microm” film applicator. (The film applicator was calibrated to 30 mils thick with a 30 mil plastic shim). The cast film was set a side to level before placing in an oven to allow excess solvent to flash off. During the initial curing tests, the NMP solvent collected on the top of the glass plates causing poor quality films that were not usable. By heating the films at a low heat, increasing the solvent rate of evaporation, eliminated this problem. Samples were clipped onto glass panels with spacers between the panels to allow for solvent to evaporate during curing. The curing cycle was as follows:
(i) ambient temp @ 1-5 F/minute to 270° F. held for 60 minutes;
(ii) 2-5° F./minute to 450° F. held for 60 minutes;
(iii) 2-5° F./minute to 600° F. held for 2 hours; and
(iv) cooled at 3-15° F./minute to ambient temp.
   Cutting and Testing of the Samples

Samples were then cut to size and the coating thickness and surface measurements were documented.

Testing Progress

Each coated Kapton film has been fastened to a PMR-15 substrate at the corners so the film will not curl and can be easily placed in the thermal cycling chamber. Film assemblies were dried for 48 hours at 250° F. prior to initial baseline electrical measurements. Electrical measurements for the baseline film (12″×12″) using the mini-probe were obtained from nine (9) different locations. The film assembly experienced the first 35 thermal cycles of 0°/500°/0° F. Each 35 thermal cycles requires 81 hours and 40 minutes to complete. Resistance measurements were taken at the end of each 35-thermal cycle.

ESD Film Preparation

The initial work was all hand sprayed resulting in application variations due to operator technique. To minimize the application variation and have more process control over application parameters; an automated spraying machine was designed and built. The coating machine was comprised of an heated aluminum plate mounted to an x-y table. Carbon nanotubes were purified and processed to make an ink solution that can be applied (to any) sheet material. The PLC controller activates the x-y table to prescribed positions based on coating performance parameters. This allows ESD coatings to be applied at a predetermined thickness and resistivities depending the performance requirements of the coatings.

Samples fabricated utilizing this equipment were made by making one to three passes over PET sheets. Following the nanotube coating, the PET sheet was dip coated with an acrylic hard coat to give the surface a coating that provides protection for the ESD coating. Single sheets of ESD PIII nanofibers coated on PET as well as several of many coatings were produced.

The ohms/sq measurements were made on a Mitsubishi Chemical LorestaGP MCP-T600 meter with an ESP probe. The probe has four evenly spaced pins that are placed on the surface of the film (Table XVII). The results of the acrylic over coated SWnT samples.

High Temperature Resistive Coating

One purpose of testing is to determine the suitability of resistive materials as potential replacements for the current resistive polyimide films. This testing evaluated certain physical and electrical properties critical to the function and performance of the resistive polyimide films. This testing does not address requirements such as vibration/acoustic response, ability to repair and tie-in electrically, and qualification of resistive films to MS-573 specifications. The following critical performance requirements were evaluated:
Electrical stability after high temperature (600° F.) exposure in oxidative and inert atmospheres.
Electrical stability after exposure to water, lubricant, hydraulic fluid and jet fuel in conjunction with high temperature cycling.
Mechanical stability after cyclic moisture saturation and high temperature exposure.
Bonding process compatibility.
Screening for thermal flash resistance.
Compatibility with subsequent processes and materials.

Testing was in triplicate and included the current baseline material as a control and for comparison. Testing was intended to be aggressive and accelerated. Test conditions may not necessarily represent the actual conditions found on the air vehicle during flight.

Electrical Stability Tests

Test Coupon Configuration: Thermal aging=three (3) sheets, 12″×12″ each material; Cyclic fluids/Thermal exposure=three (3) sheets, 5″×7″ each material.

Thermal Aging (High Temperature) Exposure: Perform nine (9) baseline measurements, using a template, on 3-inch centers of each sheet of material after being installed in exposure frame. Two exposure environments is used, both at 600° F., one with circulating air (oxidizing) and one with inert atmosphere (gaseous nitrogen). Films were cycled through exposures of; 100, 250, 500, 1000 and 2000 total hours or until the surface resistivity degrades to unacceptable values (as specified by Engineering). After each exposure period, surface resistivity was measured against baseline and films were inspected for degradation or changes.

Cyclic Fluids/Thermal Exposure: 3 baseline measurements were performed using a template, on the centerline; 1 inch apart after film was installed in exposure frame. Four fluids were used for immersion; lubricant (Mil-L-7808), hydraulic fluid (Mil-H-5606), jet fuel (JP-8) and water (R/O) at 140° F. Exposure cycles consisted of 24 hours in fluid, 24 hours ambient dry with air circulation, followed by 24 hours at 600° F. with circulating air. Resistance measurements were made after the 600° F. exposure. This cycle was repeated for as many as 10 times or until films degrade.

Mechanical Stability Tests

Test Coupon Configuration: Four (4) sheets each material, 12″×14″ was cut to 2″×14″ strips for tensile testing after moisture/thermal conditioning.

Moisture/Thermal Exposure: Sheets were pre-dried, mounted in frames at 250° F. for 48 hours followed by baseline resistance measurements, using a template, on 3-inch (7.62 cm) centers on each sheet of material. Moisture-condition of the sheets at 140° F./95% RH for 5 days. Moisture conditioned sheets were exposed to 35 to 40 cycles of thermal conditioning consisting of:
Ambient to 0° F. at 10° F./minute, hold 10 minutes.
0° F. to 500° at 10° F./minute, hold at 500° F. for 30 minutes.
500° F. to 0° F. at 10° F./minute, hold at 0° F. for 10 minutes.

Resistance was measured after 35 to 40 cycles; repeat moisture conditioning followed by 35 to 40 thermal cycles.

Mechanical Testing: per ASTM D882, Procedure A. After five (5) complete moisture condition and thermal cycles with final resistance measurements, specimens were tested for tensile at 3 each at 75° F. and 500° F.

Bonding Process Compatibility

Test Coupon Configuration: One (1), 14″×14″, 10-ply fiberglass polyimide laminate was fabricated for each test material. Sheets of resistive films were bonded to laminate per applicable process specification using release film to accommodate floating roller peel test requirements. An upper 2-ply skin of the laminate was bonded as the flexible member for floating roller peel test. Coupons were machined to 1″ wide by 14″ strips for testing.

Test Coupon Conditioning: Coupons were dried at 250° F. for 48 hours and conditioned at 95% RH/140° F. for 5 days prior to testing. Travelers were used to document the % water absorption.

Coupon Testing: Peel strength was tested per ASTM D3167 (floating roller peel) at RT and 400° F. Thermal Flash Resistance (Screen only)

Test Coupon Configuration: Three (3) coupons were prepared with each resistive film. Standard 3.8″×4.3″×0.25″ (nominal) coupons were made from polyimide fiberglass prepreg. Resistive films were bonded to one face of the coupon. All coupons were coated with baseline IR coatings.

Testing for Resistance to Thermal Flash Exposure: Coupons were tested per standard test method for thermal flash exposure except test three (3) coupons, versus the usual fifteen (15). The resistance was measured using the Mini-probe before and after thermal flash exposure.

Compatibility to Subsequent Materials and Processes. This testing evaluated adhesion of the materials applied to the resistive films after installation on composite structure.

Test Coupon Configuration: Peel strength test methods were followed in accordance with current material specification. Peel members used aluminum or Monel wire gauze. Peel strength of adhesive applied to IR coating/Resistive Film/adhesive/laminate system were tested.

Test Coupon Conditioning: Test coupons were conditioned by exposure to 95% RH at 140° F. for 5 days.

Testing for Peel Strength: Tests were performed in accordance with current material specification. TGA TOS data was collected on formulated coatings and resins. Electrovac HT in air long-term, compared to carbon black long-term; Electrovac HT in air short term burn compared to carbon black short term; XC72R short term test with annotations for TOS test table; Pyraline coating with electrovac loaded at 10% and without any filler long-term test; Pyraline coating with electrovac loaded at 6% and without any filler long-term test; and Kapton and pyraline (no conductive fillers) coatings long-term test.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims.

1. An article coated with a composition containing carbon tubes that provides said article with increased thermal oxidative stability, wherein the coating of said article has a surface resistivity of at least 10⁻² ohms/sq.

2. The article of claim 1, wherein the carbon tubes comprise single-walled carbon nanotubes.

3. The article of claim 1, wherein the carbon tubes comprise carbon nanofibers.

4. The article of claim 1, which is selected from the group consisting of an electronic devise or component, an airplane part or system, or a part of a spacecraft.

5. The article of claim 1, wherein the surface resistivity is at least 10⁻¹ ohms/sq.

6. The article of claim 1, wherein the surface resistivity is at least 10⁰ ohms/sq.

7. The article of claim 1, wherein the surface resistivity is at least 10² ohms/sq.

8. The article of claim 1, wherein the surface resistivity is at least 10⁴ ohms/sq.

9. The article of claim 1, wherein the surface resistivity is at least 10⁶ ohms/sq.

10. The article of claim 1, wherein the surface resistivity is at least 10⁸ ohms/sq.

11. The article of claim 1, wherein the carbon tubes comprise no more than about 6% of said composition.

12. The article of claim 1, wherein the carbon tubes comprise no more than about 3% of said composition.

13. The article of claim 1, wherein the carbon tubes comprise no more than about 1% of said composition.

14. The article of claim 1, wherein the carbon tubes comprise no more than about 0.2% of said composition.

15. The article of claim 1, which has an increased resistance to radiation.

16. The article of claim 1, which has an increased resistance to physical or chemical stress.

17. The article of claim 1, wherein the composition further contains high-temperature ceramics, high-temperature polymers, glasses, and combinations thereof.

18. The article of claim 17, wherein the high-temperature ceramic is an aerogel.

19. A method for providing thermal oxidative stability to a coated article comprising:
coating at least a part of said article with a composition comprising carbon tubes such that said coating provides said article with a surface resistivity of at least 10⁻² ohms/sq., an increased thermal oxidative stability, and a low thermal conduction, wherein the coating comprises less than 4% carbon tubes.

20. A coating composition containing carbon tubes that provides an article to be coated with increased thermal oxidative stability, wherein the coating of said article has a surface resistivity of at least 10⁻² ohms/sq.
